(19) United States
(12) Patent Application Publication
(10) Pub. No.: US 2019/0370575 A1
(43) Pub. Date: Dec. 5, 2019

(54) Systems and Methods for Implementing Trip Checks for Vehicles

(71) Applicant: Uber Technologies, Inc., San Francisco, CA (US)

(72) Inventors: Anand Nandakumar, Huntington Beach, CA (US); Eric James Hanson, San Francisco, CA (US)

(21) Appl. No.: 16/165,550

(22) Filed: Oct. 19, 2018

Related U.S. Application Data
(60) Provisional application No. 62/678,312, filed on May 31, 2018.

(51) Int. Cl. G06K 9/00; G05D 1/00; G01C 21/34; G06F 15/18; B60R 21/015

(52) U.S. Cl. CPC G06K 9/00838; G05D 1/0088; G05D 2201/0213; G06F 15/18; B60R 21/01544; G01C 21/3438

(57) ABSTRACT

Systems and methods are directed to using machine learning in determining vehicle status and/or rider status associated with a service trip. In one example, a computer-implemented method for providing a vehicle trip check includes obtaining sensor data from one or more sensors positioned within a cabin of a vehicle, the sensor data being descriptive of objects located within the cabin of the vehicle. The method further includes inputting the sensor data to a machine-learned trip check model, and includes receiving, as an output of the machine-learned trip check model, trip check analysis data. The method further includes determining, based on the trip check analysis data, that the trip check analysis data meets one or more predetermined criteria. The method further includes in response to determining that the trip check analysis data meets the one or more predetermined criteria, generating a trip control signal associated with operation of the vehicle.

The present application is based on and claims the benefit of U.S. Provisional Application 62/678,312 having a filing date of May 31, 2018, which is incorporated by reference herein.

### FIELD

The present disclosure relates generally to operation of an autonomous vehicle for provision of a service. More particularly, the present disclosure relates to systems and methods that provide for using machine learning in determining vehicle status and/or rider status associated with a service trip prior to commencing a service trip, during a service trip, and/or upon completion of a service trip.

### BACKGROUND

An autonomous vehicle is a vehicle that is capable of sensing its environment and navigating with little to no human input. In particular, an autonomous vehicle can observe its surrounding environment using a variety of sensors and can attempt to comprehend the environment by performing various processing techniques on data collected by the sensors. This can allow an autonomous vehicle to navigate without human intervention and, in some cases, even omit the use of a human driver altogether.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method for providing a vehicle trip check. The method includes obtaining, by a computing system comprising one or more computing devices, sensor data from one or more sensors positioned within a cabin of a vehicle, the sensor data being descriptive of objects located within the cabin of the vehicle. The method further includes inputting, by the computing system, the sensor data to a machine-learned trip check model. The method further includes receiving, by the computing system as an output of the machine-learned trip check model, trip check analysis data. The method further includes determining, by the computing system and based on the trip check analysis data, that the trip check analysis data meets one or more predetermined criteria. The method further includes in response to determining that the trip check analysis data meets the one or more predetermined criteria, generating a trip control signal associated with operation of the vehicle.

Another example aspect of the present disclosure is directed to a computing system. The computing system includes one or more image sensors positioned within a cabin of a vehicle and configured to obtain image data being descriptive of objects located within the cabin of the vehicle; one or more processors; and at least one tangible, non-transitory computer readable medium that stores instructions that, when executed by the one or more processors, cause the one or more processors to perform operations. The operations include providing real-time samples of the image data to the machine-learned trip check model. The operations further include receiving, as an output of the machine-learned trip check model, trip analysis data. The operations further include generating, based at least in part on the trip check analysis data, a trip control signal associated with operation of the vehicle.

Another example aspect of the present disclosure is directed to an autonomous vehicle. The autonomous vehicle includes a sensor system including one or more sensors for obtaining image data associated with one or more objects within the autonomous vehicle and a vehicle computing system. The vehicle computing system includes one or more processors; and at least one tangible, non-transitory computer readable medium that stores instructions that, when executed by the one or more processors, cause the one or more processors to perform operations. The operations include inputting the image data to a machine-learned trip check model. The operations further include receiving, as an output of the machine-learned trip check model, trip check analysis data. The operations further include determining, based at least in part on the trip check analysis data, that the trip check analysis data meets one or more predetermined criteria. The operations further include, in response to determining that the trip check analysis data meets one or more predetermined criteria, generating a trip control signal associated with operation of the vehicle.

Other aspects of the present disclosure are directed to various systems, apparatuses, non-transitory computer-readable media, user interfaces, and electronic devices.

The autonomous vehicle technology described herein can help improve the safety of passengers of an autonomous vehicle, improve the safety of the surroundings of the autonomous vehicle, improve the experience of the rider and/or operator of the autonomous vehicle, as well as provide other improvements as described herein. Moreover, the autonomous vehicle technology of the present disclosure can help improve the ability of an autonomous vehicle to effectively provide vehicle services to others and support the various members of the community in which the autonomous vehicle is operating, including persons with reduced mobility and/or persons that are underserved by other transportation options. Additionally, the autonomous vehicle of the present disclosure may reduce traffic congestion in communities as well as provide alternate forms of transportation that may provide environmental benefits.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts a block diagram of an example system for controlling the navigation of a vehicle according to example embodiments of the present disclosure;

FIG. 2 depicts a block diagram of an example machine-learned trip check model according to example embodiments of the present disclosure;

FIG. 3 depicts a block diagram of an example trip check control system according to example embodiments of the present disclosure;

FIG. 4 depicts example trip check operations according to example embodiments of the present disclosure;

FIG. 5 depicts a flowchart diagram of example operations for trip check determinations according to example embodiments of the present disclosure;

FIG. 6 depicts a flowchart diagram of example operations for trip check determinations according to example embodiments of the present disclosure; and

FIG. 7 depicts a block diagram of an example computing system according to example embodiments of the present disclosure.

### DETAILED DESCRIPTION

Reference now will be made in detail to embodiments, one or more example(s) of which are illustrated in the drawings. Each example is provided by way of explanation of the embodiments, not limitation of the present disclosure. In fact, it will be apparent to those skilled in the art that various modifications and variations can be made to the embodiments without departing from the scope of the present disclosure. For instance, features illustrated or described as part of one embodiment can be used with another embodiment to yield a still further embodiment. Thus, it is intended that aspects of the present disclosure cover such modifications and variations.

Example aspects of the present disclosure are directed to using machine learning in determining vehicle status and/or rider status associated with a service trip prior to commencing a service trip, during a service trip, and/or upon completion of a service trip. In particular, the systems and methods of the present disclosure can allow for streamlining the verification of vehicle readiness of a vehicle before commencing a service trip and incident to/after completion of a service trip, as well as monitoring vehicle status during a service trip, and provide for reducing the need for manual intervention by remote operators.

More particularly, a vehicle, such as but not limited to an autonomous vehicle, can include one or more sensors associated with a vehicle (e.g., within a vehicle passenger cabin, a vehicle cargo compartment, etc.) that are configured to obtain sensor data (e.g., image data, audio data, etc.) associated with one or more objects (e.g., passengers, luggage, personal effects, etc.) in the vehicle. A machine-learned trip check model can be trained to receive the sensor data as input, and in response to receipt of the sensor data, generate trip check analysis data as output. The machine-learned trip check model can have been trained to learn to detect objects identified from the sensor data that correspond to objects of interest associated with determining the readiness of a vehicle to initiate stages of a service trip. The trip check model can have been further trained to determine identification criteria associated with identified objects of interest (e.g., classification, location, count, status, etc.) for use in generating an appropriate response (e.g., a trip control signal, etc.). The resultant trip check analysis data output by the machine-learned trip check model, including objects of interest, identification criteria, and/or trip control signal(s), can thus provide improvements to vehicle readiness verification, as well as vehicle status monitoring, onboard the vehicle and reduce the need for manual intervention and/or remote intervention.

More particularly, an entity (e.g., service provider, owner, manager) can use one or more vehicles (e.g., ground-based vehicles, air-based vehicles, other type vehicles, etc.) to provide a vehicle service such as a transportation service (e.g., rideshare service), a courier service, a delivery service, etc. The vehicle(s) can be autonomous vehicles that include various systems and devices configured to control the operation of the vehicle. For example, an autonomous vehicle can include an onboard vehicle computing system for operating the vehicle (e.g., located on or within the autonomous vehicle). The vehicle computing system can receive sensor data from sensor(s) onboard the vehicle (e.g., cameras, LIDAR, RADAR), attempt to comprehend the vehicle's surrounding environment by performing various processing techniques on the sensor data, and generate an appropriate motion plan through the vehicle's surrounding environment. The vehicle computing system can control (e.g., via a vehicle controller, etc.) one or more vehicle controls (e.g., actuators or other devices that control acceleration, throttle, steering, braking, etc.) to execute the motion plan. Moreover, the autonomous vehicle can be configured to communicate with one or more computing devices that are remote from the vehicle. For example, the autonomous vehicle can communicate with an operations computing system that can be associated with the entity. The operations computing system can help the entity monitor, communicate with, manage, etc. the fleet of vehicles.

According to an aspect of the present disclosure, a vehicle can include a cabin in which one or more passengers (e.g., riders) can be positioned for transport between locations (e.g., among one or more start destinations and one or more end destinations). The passenger cabin can include one or more sensors that are configured to obtain sensor data associated with the cabin interior, one or more passengers and/or objects in the vehicle cabin, and/or the like, for example, as part of a trip check system. For example, one or more image sensors (e.g., cameras and the like) can be positioned within a cabin of a vehicle and configured to obtain image data descriptive of the cabin interior, one or more passengers and/or objects located within the cabin of the vehicle, and/or the like. Similarly, one or more audio sensors (e.g., microphones and the like) can be positioned within the cabin of the vehicle and configured to obtain audio data descriptive of one or more passengers located within the cabin of the vehicle. Image sensors and/or audio sensors can be provided in a variety of locations within the vehicle cabin, including but not limited to on the vehicle dash, in an overhead location within the cabin, on interior doors or windows of a vehicle, and/or other positions configured to obtain sensor data of the cabin interior, passengers, and/or other objects of interest.

The sensor data can be obtained and provided as input to a machine-learned trip check model that is trained to determine trip analysis data, as part of the trip check system, in response to receiving the sensor data as input. In some implementations, the machine-learned trip check model can be configured to implement analysis to detect one or more objects (e.g., passengers, user personal effects/objects, luggage, cargo, safety systems, vehicle damage, etc.) within a vehicle cabin, based at least in part on the input sensor data, and provide trip analysis data as output of the model. Trip analysis data can include, for example, determinations that one or more predefined criteria (e.g., appropriate number of passengers, passengers in proper locations/seating positions, safety systems properly engaged, vehicle cabin interior readiness, etc.) have been met, that one or more objects of interest (e.g., passengers, user personal effects/objects, luggage, other cargo, non-defined objects (detected objects that are not associated with the vehicle cabin or a passenger such as refuse, unidentified objects, or the like), damage, etc.) have been detected, classifications for one or more detected objects of interest, counts of a number of detected objects having a particular classification, location of one or more objects of interest, status of objects of interest, actions/movements of objects of interest, damage or other deviation of the vehicle interior, and/or the like.

The trip check system can generate one or more trip control signals based at least in part on the trip analysis data provided as output of the model. The trip check system can provide the one or more trip control signals to an appropriate vehicle controller and/or system to assist in implementing a desired response to the trip analysis data. For example, the trip check system can generate one or more trip control signals indicating that a vehicle can be assigned for a service trip, that the vehicle is ready to commence a service trip, that a service trip has been completed successfully and/or the vehicle is ready for a new assignment, that a deviation or anomaly has been detected and one or more appropriate remediation requests/responses should be initiated, and/or the like.

For example, in some implementations, the machine-learned trip check model can provide for analysis of the sensor data and determine, prior to initiating a vehicle assignment for a new service trip, that there are no objects of interest (e.g., objects left behind by a prior passenger such as user personal objects, refuse, etc.) located within the vehicle cabin and that the vehicle cabin meets an established standard of cleanliness as part of the trip analysis data output from the model. Based on the trip analysis data, the trip check system can generate one or more trip control signals indicating that the vehicle is ready for assignment for a new service trip and provide the trip control signal(s) to one or more control systems to provide for the vehicle to proceed to a new location for starting the new service trip. Alternatively, if the trip analysis data indicates an anomaly exists (e.g., that criteria have not been met such as objects remain in the vehicle, the vehicle needs to be cleaned/repaired, etc.), the trip check system can generate one or more trip control signals indicating that communication should be initiated with an operations control center (e.g. remote operator, technician, etc.) to provide for remediation of the anomaly, and/or the like.

In another example, in some implementations, the machine-learned trip check model can provide for analysis of the sensor data and detect, prior to commencing a service trip, one or more objects within the vehicle. For example, the trip check model can determine a classification, location, status, motion, the number of objects having a particular classification, and/or the like of one or more objects within the vehicle. As an example, the trip check model can determine that one or more passengers (e.g., riders) have entered the vehicle, the number of passengers in the vehicle, the location of the one or more passengers within the vehicle (e.g., where each passenger is sitting), the status of safety apparatus associated with each passenger location (e.g., seatbelt, etc.), and/or the like. The trip check model can output trip analysis data indicating, for example, whether one or more defined criteria for allowing a service trip to be commenced have been met. For example, the trip analysis data can indicate the number of passengers in the vehicle compared to a predefined number of passengers associated with a service trip (e.g., whether the number of passengers in the vehicle is at or below a defined maximum, or alternatively, if the number of passengers exceeds a defined maximum). The trip analysis data can also indicate, for example, whether all the detected passengers are located within designated seating positions (e.g., occupying the back seats of the vehicle with no passengers in the front seat, etc.). The trip analysis data can also indicate, for example, whether all the detected passengers have engaged appropriate safety devices, such as seatbelts and/or the like. Based on the trip analysis data indicating that the defined criteria for trip commencement have been met (e.g., no more than predefined (maximum) number of passengers, all passengers seated appropriately, etc.), the trip check system can generate one or more trip control signals indicating that the vehicle is ready to commence the service trip and provide the trip control signal(s) to one or more control systems to provide for the vehicle to begin the service trip (e.g., initiate travel to the service trip destination). Alternatively, if the trip analysis data indicates that defined criteria for trip commencement have not been met, the trip check system can generate one or more trip control signals indicating that one or more notifications (e.g., remediation request, etc.) should be provided to the passenger(s) indicating that one or more issues should be corrected before the trip can commence, indicating that communication should be initiated with an operations control center (e.g. remote operator, etc.) to enable resolution of an issue, and/or the like.

In another example, in some implementations, the machine-learned trip check model can provide for analysis of the sensor data and detect, upon concluding a service trip (e.g., incident to/after arriving at the service trip destination, etc.), whether one or more objects remain within the vehicle. For example, the trip check model can determine whether one or more objects (e.g., user personal effects/objects, luggage, cargo, refuse, non-defined objects, etc.) have been left behind in the vehicle by a passenger that has exited the vehicle (e.g., no passengers detected in the vehicle). The trip check model can determine a classification, location, status, count, and/or the like of one or more objects detected within the vehicle. As an example, the trip check model can determine that the one or more passengers have exited the vehicle (e.g., none of the detected objects have a passenger/rider classification), that one or more objects remain within the vehicle, and that the objects may be user personal objects, luggage, cargo, and/or the like that belong to the passenger(s). The trip check model can output trip analysis data indicating, for example, a classification and location of one or more detected objects. Based on the trip analysis data indicating that one or more objects have been left behind in the vehicle, the trip check system can generate a trip control signal indicating that one or more notifications should be provided to the passenger(s) that objects (e.g., personal effects, user/rider objects) remain in the vehicle, indicating that communication should be initiated with an operations control center (e.g., remote operator) to allow for resolving the issue (e.g., collecting, removing, storing the objects, etc.), and/or the like.

In some embodiments, the machine-learned trip check model can include various models, for example, neural networks (e.g., deep neural networks), support vector machines, decision trees, ensemble models, k-nearest neighbors models, Bayesian networks, or other types of models including linear models and/or non-linear models. Example neural networks include feed-forward neural networks, convolutional neural networks, recurrent neural networks (e.g., long short-term memory recurrent neural networks), or other forms of neural networks.

In some implementations, when training the machine-learned trip check model to analyze sensor data associated with objects in a vehicle (e.g., passengers, personal effects/objects, luggage, other cargo, refuse, non-defined objects, etc.) and generate trip analysis data, a trip check training dataset can include a large number of previously obtained representations of sensor data (e.g., sensor data comprising an empty vehicle interior, sensor data representing various states of the vehicle interior, sensor data corresponding to objects, etc.) and corresponding labels that describe corresponding trip check analysis data (e.g., object detection data, object identification data, object status data, object location data, object count data, system verification data, cabin interior deviation data, etc.) associated with the corresponding sensor data.

In some implementations, a training dataset can include a first portion of data corresponding to one or more representations of sensor data (e.g., image data) originating from sensors within the cabin of a vehicle. The sensor data can, for example, be recorded while a vehicle is in navigational operation, is being prepared for a service trip, has concluded a service trip, and/or the like. The training dataset can further include a second portion of data corresponding to labels identifying objects and/or data associated with detected objects. The labels included within the second portion of data within the training dataset can be manually annotated, automatically annotated, or annotated using a combination of automatic labeling and manual labeling.

In some implementations, to train the trip check model, a training computing system can input a first portion of a set of ground-truth data (e.g., the first portion of the training dataset corresponding to the one or more representations of sensor data) into the machine-learned trip check model to be trained. In response to receipt of such first portion, the machine-learned trip check model outputs trip analysis data. This output of the machine-learned trip check model can attempt to predict the remainder of the set of ground-truth data (e.g., the second portion of the training dataset). After such prediction, the training computing system can apply or otherwise determine a loss function that compares the trip analysis data output by the machine-learned trip check model to the remainder of the ground-truth data (e.g., ground-truth labels) which the trip check model attempted to predict. The training computing system then can backpropagate the loss function through the trip check model to train the trip check model (e.g., by modifying one or more weights associated with the trip check model). This process of inputting ground-truth data, determining a loss function, and backpropagating the loss function through the trip check model can be repeated numerous times as part of training the trip check model. For example, the process can be repeated for each of numerous sets of ground-truth data provided within the trip check training dataset.

In some implementations, the trip check model can be trained to subtract background data (e.g., ground truth data comprising an empty and/or ready vehicle interior, etc.) from captured current sensor data to determine a delta of the current sensor data from the background data. The trip check model can be trained to analyze the delta of the current sensor data to generate trip check analysis data.

According to another aspect of the present disclosure, in some implementations, a trip check system can further provide for obtaining sensor data in one or more cargo areas of a vehicle, for example before commencing a service trip (e.g., delivery service, etc.) and/or upon completion of a service trip (e.g., delivery service, etc.). The trip check system can provide the cargo area sensor data to a machine-learned trip check model to determine that cargo has been loaded successfully (e.g., loading is complete, cargo is properly loaded, etc.), for example, before commencing the service trip, and/or that cargo has been unloaded successfully, for example, after reaching a service trip destination and before assigning a new service trip.

According to another aspect of the present disclosure, in some implementations, a trip check system can further provide for monitoring status of one or more passengers within a vehicle during a service trip, for example, to help ensure the safety and comfort of the passengers. For example, a trip check system can provide for obtaining sensor data associated with the passengers in the vehicle cabin from one or more sensors in the vehicle cabin during an ongoing service trip. The trip check system can provide the sensor data as input to a machine-learned trip check model, and the trip check model can provide output descriptive of a status, action, and/or motion of one or more passengers. For example, the model can determine that one or more passengers are taking actions in the vehicle that are unsafe, such as reaching into the front seat of the vehicle, attempting to manipulate a vehicle control (e.g., grab the steering wheel, change a control setting, etc.). The trip check system can generate one or more trip control signals based on the detected passenger status, action, and/or movement, such as providing an alert and/or other notifications in the vehicle that the passenger action should be stopped, initiating contact with an operations control center (e.g. remote operator, etc.), modifying operation of the vehicle (e.g., slowing, stopping, etc.), and/or the like. As another example, the model can determine that an emergency situation may exist (e.g., passenger distress, medical emergency, prohibited item in vehicle, etc.). The trip check system can generate one or more trip control signals based on the detected situation, such as providing an alert or other notification in the vehicle (e.g., via one or more speakers located within and associated with the vehicle and/or a computing device such as a tablet or the like located within the vehicle, to a mobile device associated with a passenger (e.g., via a vehicle service application operating on a user mobile computing device)), initiating contact with a remote operator and/or emergency services, modifying operation of the vehicle (e.g., slowing, stopping, etc.), and/or the like.

The systems and methods described herein may provide a number of technical effects and benefits. By implementing streamlined detection of objects in a vehicle, such as passengers, personal effects, luggage, other cargo, and/or the like, using computing systems onboard a vehicle, the verification of vehicle readiness for commencing a service trip can be streamlined and the need for manual intervention by human operators can be reduced, thus providing for improving the speed of returning a vehicle to service following the completion of a service trip. Additionally, providing for more streamlined readiness verification onboard the vehicle can reduce time and resources needed to communicate with remote systems before a vehicle can be assigned to additional service trips. The systems and methods described herein may also provide a technical effect and benefit of reducing the need for remote operators to manually engage in determinations of vehicle readiness, freeing such remote operators to perform more critical tasks.

Accordingly, the disclosed technology can provide more effective vehicle readiness determinations and allow for increased vehicle service time as well as reduced manual intervention to prepare a vehicle to commence additional service trips.

With reference to the figures, example embodiments of the present disclosure will be discussed in further detail.

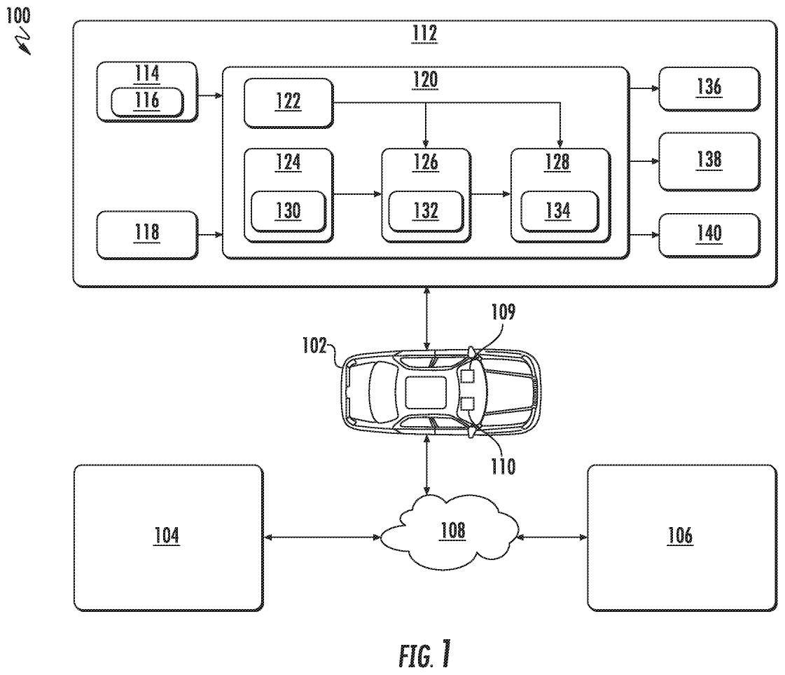

FIG. 1 depicts a block diagram of an example system 100 for controlling the navigation of a vehicle according to example embodiments of the present disclosure. As illustrated, FIG. 1 shows a system 100 that includes a communication network 108; an operations computing system 104; one or more remote computing devices 106; a vehicle 102; one or more passenger compartment image sensors 109; one or more passenger compartment audio sensors 110; a vehicle computing system 112; one or more autonomy system sensors 114; autonomy system sensor data 116; a positioning system 118; an autonomy computing system 120; map data 122; a perception system 124; a prediction system 126; a motion planning system 128; state data 130; prediction data 132; motion plan data 134; a communication system 136; a vehicle control system 138; and a human-machine interface 140.

The operations computing system 104 can be associated with a service provider that can provide one or more vehicle services to a plurality of users via a fleet of vehicles that includes, for example, the vehicle 102. The vehicle services can include transportation services (e.g., rideshare services), courier services, delivery services, and/or other types of services.

The operations computing system 104 can include multiple components for performing various operations and functions. For example, the operations computing system 104 can include and/or otherwise be associated with the one or more computing devices that are remote from the vehicle 102. The one or more computing devices of the operations computing system 104 can include one or more processors and one or more memory devices. The one or more memory devices of the operations computing system 104 can store instructions that when executed by the one or more processors cause the one or more processors to perform operations and functions associated with operation of a vehicle including receiving sensor data and/or vehicle data from a vehicle (e.g., the vehicle 102) or one or more remote computing devices, generating trip check associated data (e.g., prior to starting a new trip, during a trip, upon completion of a trip, etc.) based at least in part on the sensor data and/or the vehicle data, and/or determining a trip check control signal associated with the operation of the vehicle.

For example, the operations computing system 104 can be configured to monitor and communicate with the vehicle 102 and/or its users to coordinate a vehicle service provided by the vehicle 102. To do so, the operations computing system 104 can manage a database that includes data including vehicle status data associated with the status of vehicles including the vehicle 102 The vehicle status data can include a location of a vehicle (e.g., a latitude and longitude of a vehicle), the availability of a vehicle (e.g., whether a vehicle is available to pick-up or drop-off passengers and/or cargo), the state of objects external to a vehicle (e.g., the physical dimensions and/or appearance of objects external to the vehicle), the state of objects internal to a vehicle, and/or the like.

The operations computing system 104 can communicate with the one or more remote computing devices 106 and/or the vehicle 102 via one or more communications networks including the communications network 108. The communications network 108 can exchange (send or receive) signals (e.g., electronic signals) or data (e.g., data from a computing device) and include any combination of various wired (e.g., twisted pair cable) and/or wireless communication mechanisms (e.g., cellular, wireless, satellite, microwave, and radio frequency) and/or any desired network topology (or topologies). For example, the communications network 108 can include a local area network (e.g. intranet), wide area network (e.g. Internet), wireless LAN network (e.g., via Wi-Fi), cellular network, a SATCOM network, VHF network, a HF network, a WiMAX based network, and/or any other suitable communications network (or combination thereof) for transmitting data to and/or from the vehicle 102.

Each of the one or more remote computing devices 106 can include one or more processors and one or more memory devices. The one or more memory devices can be used to store instructions that when executed by the one or more processors of the one or more remote computing devise 106 cause the one or more processors to perform operations and/or functions including operations and/or functions associated with the vehicle 102 including exchanging (e.g., sending and/or receiving) data or signals with the vehicle 102, monitoring the state of the vehicle 102, and/or controlling the vehicle 102. The one or more remote computing devices 106 can communicate (e.g., exchange data and/or signals) with one or more devices including the operations computing system 104 and the vehicle 102 via the communications network 108. For example, the one or more remote computing devices 106 can request the location and/or status of the vehicle 102 via the communications network 108.

The one or more remote computing devices 106 can include one or more computing devices (e.g., a desktop computing device, a laptop computing device, a smart phone, and/or a tablet computing device) that can receive input or instructions from a user or exchange signals or data with an item or other computing device or computing system (e.g., the operations computing system 104). Further, the one or more remote computing devices 106 can be used to determine and/or modify one or more states of the vehicle 102 including a location (e.g., a latitude and longitude), a velocity, acceleration, a trajectory, and/or a path of the vehicle 102 based in part on signals or data exchanged with the vehicle 102. In some implementations, the operations computing system 104 can include the one or more remote computing devices 106.

The vehicle 102 can be a ground-based vehicle (e.g., an automobile), an aircraft, and/or another type of vehicle. The vehicle 102 can be an autonomous vehicle that can perform various actions including driving, navigating, and/or operating, with minimal and/or no interaction from a human driver. The autonomous vehicle 102 can be configured to operate in one or more modes including, for example, a fully autonomous operational mode, a semi-autonomous operational mode, a park mode, and/or a sleep mode. A fully autonomous (e.g., self-driving) operational mode can be one in which the vehicle 102 can provide driving and navigational operation with minimal and/or no interaction from a human driver present in the vehicle. A semi-autonomous operational mode can be one in which the vehicle 102 can operate with some interaction from a human driver present in the vehicle. Park and/or sleep modes can be used between operational modes while the vehicle 102 performs various actions including waiting to provide a subsequent vehicle service, and/or recharging between operational modes.

Furthermore, the vehicle 102 can include the one or more passenger compartment sensors, such as image sensors 109 and/or audio sensors 110, which can be positioned within a vehicle cabin and configured to obtain sensor data (e.g., image data and/or audio data) associated with one or more passengers of the vehicle and/or one or more objects within the vehicle. For example, one or more image sensors 109 (e.g., cameras and the like) can be positioned within a cabin of the vehicle 102 and configured to obtain image data descriptive of one or more passengers or objects located within the cabin of the vehicle 102. Similarly, one or more audio sensors 110 (e.g., microphones and the like) can be positioned within the cabin of the vehicle 102 and configured to obtain audio data descriptive of one or more passengers located within the cabin of the vehicle 102. Image sensors 109 and/or audio sensors 110 can be provided in a variety of locations within the vehicle cabin, including but not limited to on the vehicle dash, in an overhead location within the cabin, and/or on interior doors or windows of a vehicle (e.g., vehicle 102), or other positions configured to obtain image data of passengers and/or objects. It should be appreciated that vehicles, services, and/or applications that gather sensor data (e.g., image data obtained by image sensors 109 and/or audio data obtained by audio sensors 110) as described herein can be configured with options for permissions to be obtained from vehicle passengers before such sensor data is collected for authorized use in accordance with the disclosed techniques.

An indication, record, and/or other data indicative of the state of the vehicle, the state of one or more passengers of the vehicle, the state of one or more objects internal to the vehicle, and/or the state of an environment including one or more objects (e.g., the physical dimensions and/or appearance of the one or more objects) can be stored locally in one or more memory devices of the vehicle 102. Additionally, the vehicle 102 can provide data indicative of the state of the vehicle, the state of one or more passengers of the vehicle, the state of one or more objects internal to the vehicle, and/or the state of an environment to the operations computing system 104, which can store an indication, record, and/or other data indicative of such states in one or more memory devices associated with the operations computing system 104 (e.g., remote from the vehicle).

The vehicle 102 can include and/or be associated with the vehicle computing system 112. The vehicle computing system 112 can include one or more computing devices located onboard the vehicle 102. For example, the one or more computing devices of the vehicle computing system 112 can be located on and/or within the vehicle 102. The one or more computing devices of the vehicle computing system 112 can include various components for performing various operations and functions. For instance, the one or more computing devices of the vehicle computing system 112 can include one or more processors and one or more tangible, non-transitory, computer readable media (e.g., memory devices). The one or more tangible, non-transitory, computer readable media can store instructions that when executed by the one or more processors cause the vehicle 102 (e.g., its computing system, one or more processors, and other devices in the vehicle 102) to perform operations and functions, including those described herein for determining trip check data and/or controlling the vehicle 102.

As depicted in FIG. 1, the vehicle computing system 112 can include the one or more autonomy system sensors 114; the positioning system 118; the autonomy computing system 120; the communication system 136; the vehicle control system 138; and the human-machine interface 140. One or more of these systems can be configured to communicate with one another via a communication channel. The communication channel can include one or more data buses (e.g., controller area network (CAN)), on-board diagnostics connector (e.g., OBD-II), and/or a combination of wired and/or wireless communication links. The onboard systems can exchange (e.g., send and/or receive) data, messages, and/or signals amongst one another via the communication channel.

The one or more autonomy system sensors 114 can be configured to generate and/or store data including the autonomy sensor data 116 associated with one or more objects that are proximate to the vehicle 102 (e.g., within range or a field of view of one or more of the one or more sensors 114). The one or more autonomy system sensors 114 can include a Light Detection and Ranging (LIDAR) system, a Radio Detection and Ranging (RADAR) system, one or more cameras (e.g., visible spectrum cameras and/or infrared cameras), motion sensors, and/or other types of imaging capture devices and/or sensors. The autonomy sensor data 116 can include image data, radar data, LIDAR data, and/or other data acquired by the one or more autonomy system sensors 114. The one or more objects can include, for example, pedestrians, vehicles, bicycles, and/or other objects. The one or more objects can be located on various parts of the vehicle 102 including a front side, rear side, left side, right side, top, or bottom of the vehicle 102. The autonomy sensor data 116 can be indicative of locations associated with the one or more objects within the surrounding environment of the vehicle 102 at one or more times. For example, autonomy sensor data 116 can be indicative of one or more LIDAR point clouds associated with the one or more objects within the surrounding environment. The one or more autonomy system sensors 114 can provide the autonomy sensor data 116 to the autonomy computing system 120.

In addition to the autonomy sensor data 116, the autonomy computing system 120 can retrieve or otherwise obtain data including the map data 122. The map data 122 can provide detailed information about the surrounding environment of the vehicle 102. For example, the map data 122 can provide information regarding: the identity and location of different roadways, road segments, buildings, or other items or objects (e.g., lampposts, crosswalks and/or curb); the location and directions of traffic lanes (e.g., the location and direction of a parking lane, a turning lane, a bicycle lane, or other lanes within a particular roadway or other travel way and/or one or more boundary markings associated therewith); traffic control data (e.g., the location and instructions of signage, traffic lights, or other traffic control devices); and/or any other map data that provides information that assists the vehicle computing system 112 in processing, analyzing, and perceiving its surrounding environment and its relationship thereto.

The vehicle computing system 112 can include a positioning system 118. The positioning system 118 can determine a current position of the vehicle 102. The positioning system 118 can be any device or circuitry for analyzing the position of the vehicle 102. For example, the positioning system 118 can determine position by using one or more of inertial sensors, a satellite positioning system, based on IP/MAC address, by using triangulation and/or proximity to network access points or other network components (e.g., cellular towers and/or Wi-Fi access points) and/or other suitable techniques. The position of the vehicle 102 can be used by various systems of the vehicle computing system 112 and/or provided to one or more remote computing devices (e.g., the operations computing system 104 and/or the remote computing device 106). For example, the map data 122 can provide the vehicle 102 relative positions of the surrounding environment of the vehicle 102. The vehicle 102 can identify its position within the surrounding environment (e.g., across six axes) based at least in part on the data described herein. For example, the vehicle 102 can process the autonomy sensor data 116 (e.g., LIDAR data, camera data) to match it to a map of the surrounding environment to get an understanding of the vehicle's position within that environment (e.g., transpose the vehicle's position within its surrounding environment).

The autonomy computing system 120 can include a perception system 124, a prediction system 126, a motion planning system 128, and/or other systems that cooperate to perceive the surrounding environment of the vehicle 102 and determine a motion plan for controlling the motion of the vehicle 102 accordingly. For example, the autonomy computing system 120 can receive the autonomy sensor data 116 from the one or more autonomy system sensors 114, attempt to determine the state of the surrounding environment by performing various processing techniques on the autonomy sensor data 116 (and/or other data), and generate an appropriate motion plan through the surrounding environment. The autonomy computing system 120 can control the one or more vehicle control systems 138 to operate the vehicle 102 according to the motion plan.

The perception system 124 can identify one or more objects that are proximate to the vehicle 102 based on autonomy sensor data 116 received from the autonomy system sensors 114. In particular, in some implementations, the perception system 124 can determine, for each object, state data 130 that describes a current state of such object. As examples, the state data 130 for each object can describe an estimate of the object's: current location (also referred to as position); current speed; current heading (which may also be referred to together as velocity); current acceleration; current orientation; size/footprint (e.g., as represented by a bounding shape such as a bounding polygon or polyhedron); class of characterization (e.g., vehicle class versus pedestrian class versus bicycle class versus other class); yaw rate; and/or other state information. In some implementations, the perception system 124 can determine state data 130 for each object over a number of iterations. In particular, the perception system 124 can update the state data 130 for each object at each iteration. Thus, the perception system 124 can detect and track objects (e.g., vehicles, bicycles, pedestrians, etc.) that are proximate to the vehicle 102 over time, and thereby produce a presentation of the world around an vehicle 102 along with its state (e.g., a presentation of the objects of interest within a scene at the current time along with the states of the objects).

The prediction system 126 can receive the state data 130 from the perception system 124 and predict one or more future locations and/or moving paths for each object based on such state data. For example, the prediction system 126 can generate prediction data 132 associated with each of the respective one or more objects proximate to the vehicle 102. The prediction data 132 can be indicative of one or more predicted future locations of each respective object. The prediction data 132 can be indicative of a predicted path (e.g., predicted trajectory) of at least one object within the surrounding environment of the vehicle 102. For example, the predicted path (e.g., trajectory) can indicate a path along which the respective object is predicted to travel over time (and/or the velocity at which the object is predicted to travel along the predicted path). The prediction system 126 can provide the prediction data 132 associated with the one or more objects to the motion planning system 128.

The motion planning system 128 can determine a motion plan and generate motion plan data 134 for the vehicle 102 based at least in part on the prediction data 132 (and/or other data). The motion plan data 134 can include vehicle actions with respect to the objects proximate to the vehicle 102 as well as the predicted movements. For instance, the motion planning system 128 can implement an optimization algorithm that considers cost data associated with a vehicle action as well as other objective functions (e.g., cost functions based on speed limits, traffic lights, and/or other aspects of the environment), if any, to determine optimized variables that make up the motion plan data 134. By way of example, the motion planning system 128 can determine that the vehicle 102 can perform a certain action (e.g., pass an object) without increasing the potential risk to the vehicle 102 and/or violating any traffic laws (e.g., speed limits, lane boundaries, signage). The motion plan data 134 can include a planned trajectory, velocity, acceleration, and/or other actions of the vehicle 102.

As one example, in some implementations, the motion planning system can determine a cost function for each of one or more candidate motion plans for the autonomous vehicle based at least in part on the current locations and/or predicted future locations and/or moving paths of the objects. For example, the cost function can describe a cost (e.g., over time) of adhering to a particular candidate motion plan. For example, the cost described by a cost function can increase when the autonomous vehicle approaches impact with another object and/or deviates from a preferred pathway (e.g., a predetermined travel route).

Thus, given information about the current locations and/or predicted future locations and/or moving paths of objects, the motion planning system can determine a cost of adhering to a particular candidate pathway. The motion planning system can select or determine a motion plan for the autonomous vehicle based at least in part on the cost function(s). For example, the motion plan that minimizes the cost function can be selected or otherwise determined. The motion planning system then can provide the selected motion plan to a vehicle controller that controls one or more vehicle controls (e.g., actuators or other devices that control gas flow, steering, braking, etc.) to execute the selected motion plan.

The motion planning system 128 can provide the motion plan data 134 with data indicative of the vehicle actions, a planned trajectory, and/or other operating parameters to the vehicle control systems 138 to implement the motion plan data 134 for the vehicle 102. For instance, the vehicle 102 can include a mobility controller configured to translate the motion plan data 134 into instructions. By way of example, the mobility controller can translate a determined motion plan data 134 into instructions for controlling the vehicle 102 including adjusting the steering of the vehicle 102 “X” degrees and/or applying a certain magnitude of braking force. The mobility controller can send one or more control signals to the responsible vehicle control component (e.g., braking control system, steering control system and/or acceleration control system) to execute the instructions and implement the motion plan data 134.

The vehicle computing system 112 can include a communications system 136 configured to allow the vehicle computing system 112 (and its one or more computing devices) to communicate with other computing devices. The vehicle computing system 112 can use the communications system 136 to communicate with the operations computing system 106 and/or one or more other remote computing devices (e.g., the one or more remote computing devices 106) over one or more networks (e.g., via one or more wireless signal connections). In some implementations, the communications system 136 can allow communication among one or more of the system on-board the vehicle 102. The communications system 136 can also be configured to enable the autonomous vehicle to communicate with and/or provide and/or receive data and/or signals from a remote computing device 106 associated with a user and/or an item (e.g., an item to be picked-up for a courier service). The communications system 136 can utilize various communication technologies including, for example, radio frequency signaling and/or Bluetooth low energy protocol. The communications system 136 can include any suitable components for interfacing with one or more networks, including, for example, one or more: transmitters, receivers, ports, controllers, antennas, and/or other suitable components that can help facilitate communication. In some implementations, the communications system 136 can include a plurality of components (e.g., antennas, transmitters, and/or receivers) that allow it to implement and utilize multiple-input, multiple-output (MIMO) technology and communication techniques.

The vehicle computing system 112 can include the one or more human-machine interfaces 140. For example, the vehicle computing system 112 can include one or more display devices located on the vehicle computing system 112. A display device (e.g., screen of a tablet, laptop, and/or smartphone) can be viewable by a user of the vehicle 102 that is located in the front of the vehicle 102 (e.g., driver's seat, front passenger seat). Additionally, or alternatively, a display device can be viewable by a user of the vehicle 102 that is located in the rear of the vehicle 102 (e.g., a back passenger seat).

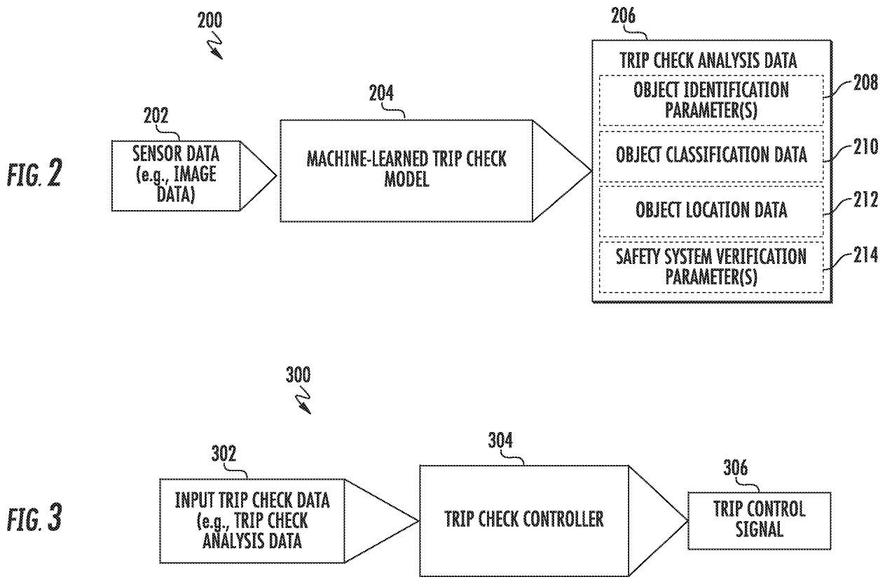

FIG. 2 depicts a block diagram 200 of an example machine-learned trip check model according to example embodiments of the present disclosure. In some implementations, as illustrated in FIG. 2, a machine-learned trip check model 204 can receive sensor data 202 (e.g., image data, etc.) as input to the model 204. The machine learned trip check model 204 can then generate trip check analysis data 206 as output of the model 204.

As illustrated in FIG. 2, sensor data 202 (e.g., image data, etc.) associated with one or more passengers of a vehicle (e.g., a vehicle 102 as depicted in FIG. 1, etc.), one or more objects internal to the vehicle, one or more objects external to the vehicle, and/or the like can be obtained from one or more sensors positioned within a cabin of the vehicle (e.g., image sensors 109 and/or audio sensors 110 of FIG. 1, etc.). The sensors (e.g., image sensors and/or audio sensors, etc.) can be provided in a variety of locations within a vehicle cabin, including but not limited to on the vehicle dash, in an overhead location within the cabin, on interior doors or windows of a vehicle, and/or other positions configured to obtain image data of passengers, other objects, cabin interior, and/or the like.

The sensor data 202 can be provided as input to a machine-learned trip check model 204 that is trained to determine trip check data in response to receiving the sensor data 202 as input. In some implementations, the machine-learned trip check model 204 can include one or more layers configured to implement one or more types of analysis which can be used to determine trip check data based in part on the sensor data 202.

As an example, the machine-learned trip check model 204 can be configured to implement analysis of current image data (e.g., contained in sensor data 202) by one or more image analysis layers within the machine-learned trip check model 204. The machine-learned trip check model 204 can be trained to subtract background image data (e.g., ground truth data comprising an empty vehicle interior, a vehicle interior that is ready for a trip assignment, etc.) from the sensor data 202 captured by the one or more sensors (e.g., image sensor(s) 109 of FIG. 1) and to determine a delta remaining in the image data. The machine-learned trip check model 204 can be trained to analyze the remaining image data delta to determine trip check analysis data (e.g., identify objects (e.g., passengers, passenger objects, discarded objects, etc.) in the vehicle, classify and/or categorize objects, determine object location, determine a count of objects having a particular classification, identify damage and/or other deviation of the vehicle interior, and/or the like).

The machine-learned trip check model 204 can be configured to output a single type or multiple types of trip check analysis data 206. For example, trip check analysis data 206 can include one or more object identification parameters 208 (e.g., objects detected based at least in part on the sensor data 202); object classification data 210; object location data 212; one or more safety system verification parameters 214 (e.g., a status (e.g., engaged, disengaged, etc.) for each of one or more safety systems (e.g., passenger restraints, etc.) of a vehicle); and/or the like.

The resultant trip check analysis data 206 that is output by the machine-learned trip check model 204 can thus provide real-time and/or historical information that can be used to streamline vehicle verification, increase vehicle readiness, improve vehicle monitoring, and/or improve passenger experience.

FIG. 3 depicts a block diagram of an example trip check control system 300 according to example embodiments of the present disclosure. In some implementations, a trip check control system 300 can include a trip check controller 304 that can receive various input data 302 (e.g., trip check analysis data such as trip check analysis data 206 of FIG. 2, etc.) and provide one or more trip control signals 306 associated with operation of the vehicle. For example, a trip check controller 304 can obtain one or more of trip check analysis data, trip data, and/or vehicle status data for use in determining one or more trip control signals 306, such as a vehicle readiness signal, a trip completion signal, a deviation detection signal, a remediation signal, a remote assistance request signal, and/or the like. In one example, based at least in part on the trip check input data 302, the trip check controller 304 can generate one or more trip control signals 306 indicating that the vehicle is ready for assignment for a new service trip and provide the trip control signal(s) to one or more control systems to provide for the vehicle to proceed to a new location for the new service trip (e.g., authorization to dispatch to a location to initiate new service trip). In another example, if the trip check controller 304 indicates an anomaly exists based at least in part on the trip check input data 302 (e.g., that criteria have not been met such as objects remain in the vehicle, the vehicle needs to be cleaned, interior damage has occurred, etc.), the trip check controller 304 can generate one or more trip control signals 306 indicating that communication should be initiated with an operations control center (e.g. remote operator, technician, etc.) to provide for remediation of the anomaly, and/or the like.

In another example, the trip check input data 302 can indicate, based on the output of the machine-learned trip check model, that one or more passengers have entered the vehicle, the count of the number of passengers in the vehicle, the location of the one or more passengers within the vehicle (e.g., where each passenger is sitting), the status of safety apparatus associated with each passenger location (e.g., seatbelt, airbag, other restraint, etc.), and/or the like. The machine-learned trip check model can output trip check analysis data indicating, for example, whether one or more defined criteria for allowing a service trip to be commenced have been met (e.g., count of passengers at or below predefined number, passengers located appropriately, safety systems engaged properly, etc.). Based at least in part on the trip check input data 302, the trip check controller 304 can generate one or more trip control signals 306 indicating that the vehicle is ready to commence the service trip and provide the trip control signal(s) to one or more control systems to provide for the vehicle to begin the service trip (e.g., initiate travel to a destination). As another example, if the trip check controller 304 indicates, based at least in part on the trip check input data 302, that defined criteria for trip commencement have not been met, the trip check controller 304 can generate one or more trip control signals indicating that one or more notifications should be provided to the passenger(s) indicating that one or more issues should be corrected before the trip can commence, indicating that communication should be initiated with an operations control center (e.g. remote operator, etc.) to enable resolution of an issue, and/or the like.

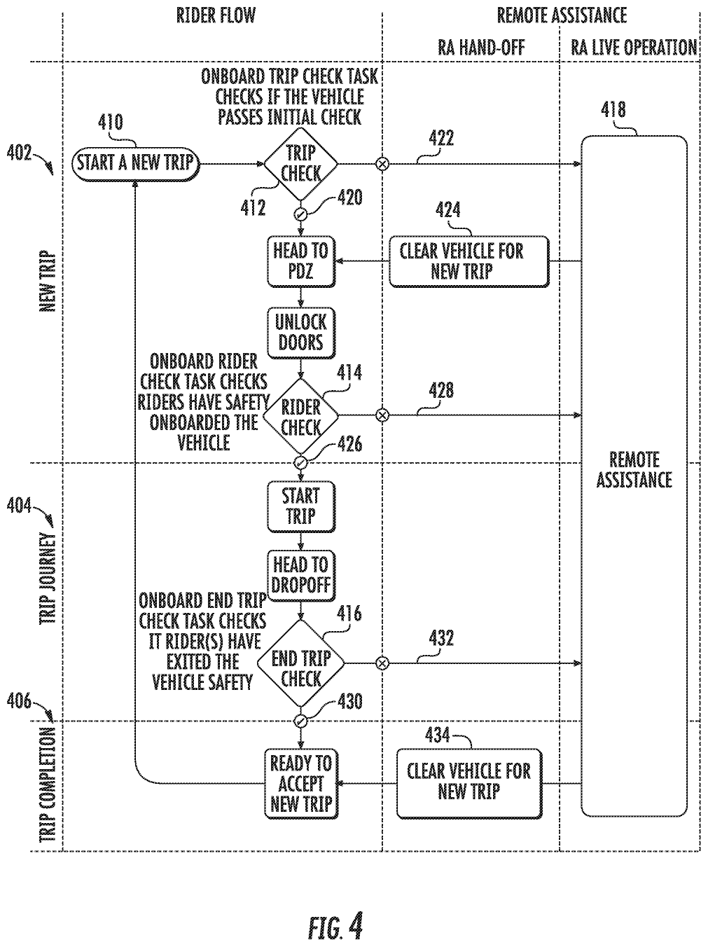

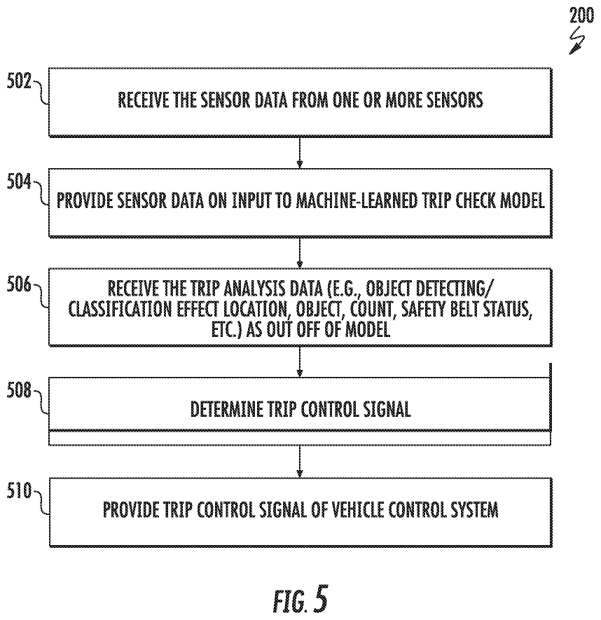

FIG. 4 depicts an example flowchart diagram of trip check operations 400 according to example embodiments of the present disclosure. As described herein, in some implementations, a machine-learned trip check model can be trained to receive sensor data as input, and in response to receipt of sensor data, generate trip check analysis data as output for use in determining vehicle status and/or rider status associated with a service trip prior to commencing a service trip, during a service trip, and/or upon completion of a service trip (e.g., incident to and/or after conclusion of a service trip at the destination). In particular, the present disclosure can allow for streamlining the verification of vehicle readiness of a vehicle before commencing a service trip and after completion of a service trip, as well as monitoring vehicle status during a service trip, and provide for reducing the need for manual intervention (e.g., by remote operators, etc.). One or more portion(s) of the operations 400 can be implemented by one or more computing devices such as, for example, the operations computing system 104 of FIG. 1, the vehicle computing system 112 of FIG. 1, the computing system 710 of FIG. 7, the machine learning computing system 750 of FIG. 7, and/or the like. Each respective portion of the operations 400 can be performed by any (or any combination) of the one or more computing devices. Moreover, one or more portion(s) of the operations 400 can be implemented as an algorithm on the hardware components of the device(s) described herein (e.g., as in FIGS. 1 and 7), for example, to provide for generating trip check data and/or trip control signals as described herein. FIG. 4 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, and/or modified in various ways without deviating from the scope of the present disclosure.

According to an example implementation of the present disclosure, trip check operations can be performed as part of a vehicle trip assignment and/or commencement 402, trip progression 404, and/or trip completion 406.

In some implementations, trip check operations 400 can be initiated prior to or as part of assigning a vehicle to a new trip service 410. At 412, an initial trip check analysis can be performed (e.g., using one or more machine-learned trip check models) to determine if a vehicle is ready for assignment of a new trip service. For example, the initial trip check analysis can include obtaining sensor data (e.g., image data) descriptive of the interior cabin of the vehicle and providing the sensor data as input to a machine-learned model. The initial trip check analysis can include generating trip check analysis data, for example, determining whether one or more objects or other interior deviations/anomalies (e.g., objects left behind by a prior passenger within the vehicle cabin, damage, interior cleanliness issues, etc.) are present within the vehicle cabin.

One or more trip control signals can be generated based in part on the initial trip check analysis and can be provided to an appropriate vehicle controller, vehicle system, and/or remote system to assist in implementing a desired response to the trip check analysis data. For example, if no objects and/or deviations are found within the vehicle cabin, one or more trip control signals 420 can be generated and provided to a vehicle computing system, one or more vehicle control systems, and/or one or more remote computing systems to indicate that the vehicle is ready to be assigned to a new trip service and the vehicle can be assigned to the new trip service (e.g., provide authorization for the vehicle to proceed to a new service trip starting location). The one or more trip control signals 420 can be provided to one or more vehicle control systems to initiate the vehicle proceeding to a designated starting point for the trip service and providing access to the vehicle by one or more passengers associated with the trip service upon reaching the starting point. Alternatively, if the initial trip check analysis indicates a deviation/anomaly exists (e.g., that criteria have not been met such as objects remain in the vehicle, the vehicle needs to be cleaned, etc.), one or more trip control signals 422 can be generated indicating that communication should be initiated with an operations control center, such as remote operator/remote assistance 418, and/or the like to provide for remediation of the anomaly, and/or the like. In some implementations, upon a review and/or resolution of the anomaly, one or more control signals 424 can be provided from the operations control center (e.g., remote operator/remote assistance 418, etc.) to the vehicle (e.g., the vehicle computing system, etc.) allowing the vehicle to be assigned to the new trip service (e.g., provide authorization for the vehicle to proceed to a trip starting point) and initiating vehicle operation such that the vehicle can proceed to a designated starting point for the trip service.

At 414, a second trip check analysis can be performed (e.g., using one or more machine-learned trip check models) to determine if a vehicle is ready to commence an assigned trip service. For example, the second trip check analysis can include obtaining sensor data (e.g., image data) descriptive of the interior cabin of the vehicle and providing the sensor data as input to a machine-learned model. The second trip check analysis can include generating trip check analysis data, for example, determining that one or more passengers have entered the vehicle, the number of passengers in the vehicle, the location/positioning of the one or more passengers within the vehicle (e.g., where each passenger is sitting), the status of safety apparatus associated with each passenger location (e.g., seatbelt, etc.), and/or the like. In some implementations, the machine-learned trip check model can output trip check analysis data indicating, for example, whether one or more defined criteria for allowing a trip service to be commenced have been met.

One or more trip control signals can be generated based in part on the second trip check analysis and can be provided to an appropriate vehicle controller, vehicle system, and/or remote system to assist in implementing a desired response to the trip check analysis data. For example, if the second trip check analysis indicates that the defined criteria for trip commencement have been met (e.g., no more than a predefined number of passengers, all passengers seated appropriately, etc.), one or more trip control signals 426 can be generated and provided to a vehicle computing system, one or more vehicle controls, and/or other vehicle systems to provide for the vehicle to commence the trip service (e.g., initiate travel to the trip service destination via one or more vehicle controls, vehicle computing system, etc.).

Alternatively, if the second trip check analysis indicates that defined criteria for trip commencement have not been met, the trip check system can generate one or more trip control signals 428 indicating that one or more notifications should be provided to the passenger(s) indicating that one or more issues should be corrected before the trip can commence, indicating that communication should be initiated with an operations control center (e.g. remote operator/remote assistance 418, etc.) to enable resolution of an issue/deviation, and/or the like. Upon resolution of the one or more issues, the vehicle can commence the new trip service and proceed to a designated destination for the trip service. In some implementations, upon a review and/or resolution of the issue(s), one or more control signals can be provided from the operations control center to allow the vehicle to commence the new trip service and proceed to a designated destination for the trip service.

At 416, a third trip check analysis can be performed (e.g., using one or more machine-learned trip check models) to determine if a vehicle has successfully completed the assigned trip service. For example, the third trip check analysis can include obtaining sensor data (e.g., image data) descriptive of the interior cabin of the vehicle and providing the sensor data as input to a machine-learned model. The second trip check analysis can include generating trip check analysis data, for example, determining whether one or more objects remain within the vehicle and/or other deviations are present within the vehicle cabin. For example, the trip check model can determine whether the one or more passengers have exited the vehicle, whether the vehicle doors have been secured, whether one or more objects (e.g., user personal objects, luggage, other cargo, refuse, etc.) have been left behind in the vehicle by a passenger that has exited the vehicle, and/or the like.

One or more trip control signals can be generated based in part on the third trip check analysis and can be provided to an appropriate vehicle controller, vehicle system, and/or remote system to assist in implementing a desired response to the trip check analysis data. For example, if the third trip check analysis indicates that one or more objects have been left behind in the vehicle (e.g., one or more objects having a classification of user personal object, luggage, cargo, etc. are detected and no objects having a classification of passenger/rider are detected), one or more trip control signals 432 can be generated and provided to one or more vehicle systems, remote computing systems, and/or the like indicating that one or more notifications should be provided to the passenger(s) that objects remain in the vehicle, indicating that the vehicle should remain at that location, indicating that communication should be initiated with an operations control center (e.g., remote operator/remote assistance 418) to allow for resolving the issue, and/or the like. In some implementations, if the third trip check analysis indicates that one or more discarded objects have been left behind in the vehicle (e.g., one or more objects having a classification of refuse, non-defined object, etc. are detected and no objects having a classification of passenger/rider are detected), one or more trip control signals 432 can be generated and provided to one or more vehicle systems, remote computing systems, and/or the like indicating that the vehicle should proceed to a service location, indicating that communication should be initiated with an operations control center (e.g., remote operator/remote assistance 418) to allow for resolving the issue, and/or the like. In some implementations, upon a review and/or resolution of the issue(s), one or more control signals 434 can be provided from the operations control center (e.g., remote operator/remote assistance 418, etc.) to the vehicle (e.g., the vehicle computing system, etc.) allowing the vehicle to be placed in a ready status (e.g., awaiting a new trip service assignment, etc.).

Alternatively, if the second trip check analysis indicates that the passengers have fully exited the vehicle, that the vehicle doors are secured, that no objects remain in the vehicle, and/or that no other interior deviations exist, one or more trip control signals 430 can be generated and provided to a vehicle computing system, one or more vehicle control systems, and/or one or more remote computing systems to indicate that the vehicle can be placed in a ready status (e.g., awaiting a new trip service assignment, etc.).

In some implementations, one or more different machine-learned models may be provided for different stages of the trip check operations (e.g., vehicle trip assignment and/or commencement 402, trip progression 404, and/or trip completion 406). For example, in some implementations, one or more first machine-learned trip check models may be provided to implement the first trip check analysis 412; one or more second machine-learned trip check models may be provided to implement the second trip check analysis 414; and one or more third machine-learned trip check models may be provided to implement the third trip check analysis 416. In such implementations, the first machine-learned trip check model(s), second machine-learned trip check model(s), and/or third machine-learned trip check model(s) may be trained using distinct sets of training data such that the first machine-learned trip check model(s), second machine-learned trip check model(s), and/or third machine-learned trip check model(s) provide for generation of different types of trip check analysis data.

FIG. 5 depicts a flowchart diagram of example method 500 including operations for trip check determinations according to example embodiments of the present disclosure. As described herein, in some implementations, a machine-learned trip check model can be trained to receive sensor data as input, and in response to receipt of sensor data, generate trip check analysis data as output. One or more portion(s) of the method 500 can be implemented by one or more computing devices such as, for example, the operations computing system 104 of FIG. 1, the vehicle computing system 112 of FIG. 1, the computing system 710 of FIG. 7, the machine learning computing system 750 of FIG. 7, and/or the like. Each respective portion of the method 500 can be performed by any (or any combination) of the one or more computing devices. Moreover, one or more portion(s) of the method 500 can be implemented as an algorithm on the hardware components of the device(s) described herein (e.g., as in FIGS. 1 and 7), for example, to provide for generating trip check data and/or trip control signals as described herein. FIG. 5 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, and/or modified in various ways without deviating from the scope of the present disclosure.

At 502, the method 500 can include one or more computing devices included within a computing system (e.g., computing system 104, 112, 710, 750, and/or the like) receiving sensor data from one or more sensors positioned within a vehicle. For example, a passenger cabin of a vehicle can include one or more sensors that are configured to obtain sensor data associated with the one or more objects (e.g., passengers, other objects, vehicle damage, etc.). As an example, one or more image sensors (e.g., cameras and the like) can be positioned within a cabin of a vehicle and configured to obtain image data descriptive of one or more objects located within the cabin of the vehicle. Similarly, one or more audio sensors (e.g., microphones and the like) can be positioned within the cabin of the vehicle and configured to obtain audio data descriptive of one or more objects located within the cabin of the vehicle. Image sensors and/or audio sensors can be provided in a variety of locations within the vehicle cabin, including but not limited to on the vehicle dash, in an overhead location within the cabin, on interior doors or windows of a vehicle, and/or other positions configured to obtain sensor data as necessary.

At 504, the computing system can provide the sensor data as input to a machine-learned trip check model that is trained to determine trip check analysis data in response to receiving the sensor data as input. In some implementations, the machine-learned trip check model can be configured to implement one or more types of analysis.

At 506, the computing system can receive trip check analysis data as output of the machine-learned trip check model. As an example, trip check analysis data can include one or more object identification parameters (e.g., objects detected based at least in part on the sensor data); object classification data; object location data; one or more safety system verification parameters (e.g., a status (e.g., engaged, disengaged, etc.) for each of one or more safety systems (e.g., passenger restraints, etc.) of a vehicle), vehicle interior damage/deviation data, and/or the like.

At 508, the computing system can determine a trip control signal. For example, based on analysis of the trip check analysis data, a trip check controller can determine one or more trip control signals as output. In some implementations, a computing system can correlate the trip check analysis data with other data, for example, vehicle status data, trip data, and/or the like, in making determinations regarding the one or more trip control signals. In some implementations, a trip control signal can include, for example, a vehicle readiness signal, a trip completion signal, a deviation detection signal, a remediation signal, a remote assistance request signal, and/or the like.

At 510, the computing system can provide the one or more trip control systems to a vehicle control system to provide for an appropriate response (e.g., commencing a trip, providing one or more modifications, updating a vehicle status, initiating a communication to a remote operations center, etc.).

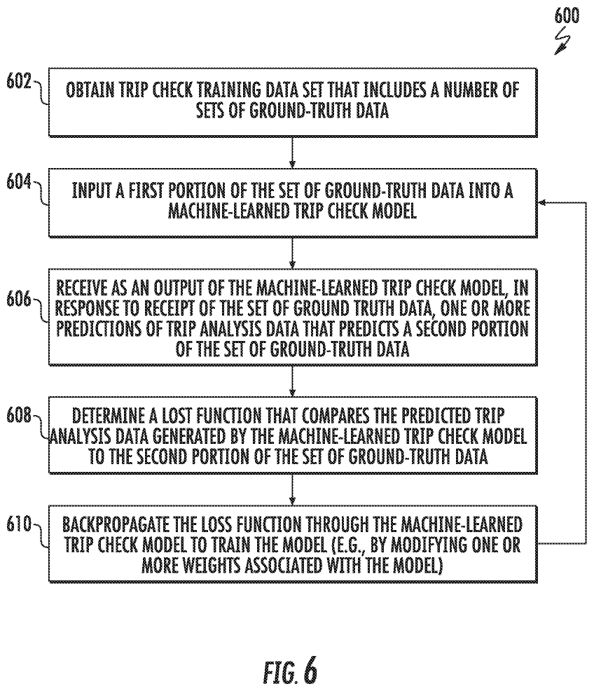

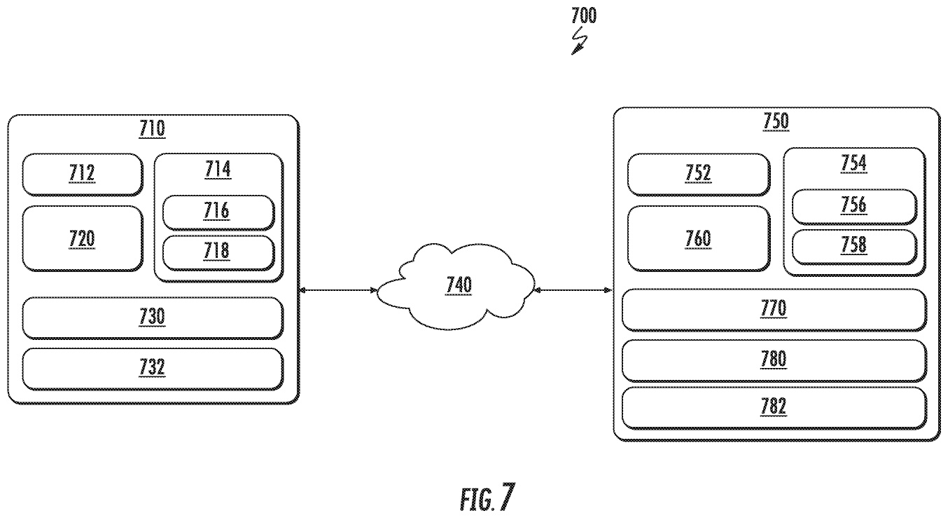

FIG. 6 depicts a flowchart diagram of an example method 600 of training a machine-learned trip check model according to example embodiments of the present disclosure. As described herein, in some implementations, a machine-learned trip check model can be trained to receive sensor data as input, and in response to receipt of the sensor data, generate trip check analysis data as output. One or more portion(s) of the method 600 can be implemented by one or more computing devices such as, for example, the operations computing system 104 of FIG. 1, the vehicle computing system 112 of FIG. 1, the computing system 710 of FIG. 7, the machine learning computing system 750 of FIG. 7, and/or the like. Each respective portion of the method 600 can be performed by any (or any combination) of the one or more computing devices. Moreover, one or more portion(s) of the method 600 can be implemented as an algorithm on the hardware components of the device(s) described herein (e.g., as in FIGS. 1 and 7), for example, to provide for generating trip check data and/or trip control signals as described herein. FIG. 6 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, and/or modified in various ways without deviating from the scope of the present disclosure.

At 602, the method 600 can include one or more computing devices included within a computing system (e.g., computing system 104, 112, 710, 750, and/or the like) obtaining a trip check training dataset that includes a number of sets of ground-truth data. For example, to train a machine-learned trip check model to analyze sensor data (e.g., image data, audio data, etc.) associated with objects within a vehicle (e.g., passengers, other objects, interior deviations, etc.) and generate trip check analysis data, a trip check training dataset can be obtained that includes a large number of previously obtained representations of sensor data (e.g., sensor data comprising an empty vehicle interior, sensor data representing various states of the vehicle interior, sensor data corresponding to objects, etc.) and corresponding labels that describe corresponding trip check analysis data (e.g., vehicle interior state data, object detection data, object identification data, object status data, system verification data, interior deviation data, etc.) associated with the corresponding sensor data.

The trip check training dataset can include a first portion of data corresponding to one or more representations of sensor data (e.g., image data and/or audio data) originating from sensors within the cabin of a vehicle. The sensor data can, for example, be recorded while a vehicle is in navigational operation, is being prepared for trip assignment, is in a state of readiness for trip assignment, and/or the like. The trip check training dataset can further include a second portion of data corresponding to labels identifying trip check data associated with detected objects and/or vehicle status. The labels included within the second portion of data within the training dataset can be manually annotated, automatically annotated, or annotated using a combination of automatic labeling and manual labeling.

At 604, the computing system can input a first portion of a set of ground-truth data into a machine-learned trip check model. For example, to train the trip check model, a training computing system can input a first portion of a set of ground-truth data (e.g., the first portion of the training dataset corresponding to the one or more representations of sensor data) into the machine-learned trip check model to be trained. As an example, the set of training data can include sensor data representative of an empty vehicle cabin, a vehicle cabin that is in a readiness state, and/or the like. In another example, the set of training data can include a variety of representative of objects that could be detected within a vehicle, object locations, vehicle interior deviations, and/or the like.

At 606, the computing system can receive as output of the machine-learned trip check model, in response to receipt of the ground-truth data, one or more predictions of trip check analysis data that predicts a second portion of the set of ground-truth data. For example, in response to receipt of a first portion of a set of ground-truth data, the machine-learned trip check model can output detected trip check analysis data, for example, vehicle interior state data, object detection data, object identification/classification data, object status data, object location data, safety system verification data, interior deviation data, and/or the like This output of the machine-learned trip check model can predicts the remainder of the set of ground-truth data (e.g., the second portion of the training dataset).

At 608, the computing system can determine a loss function that compares the predicted trip check analysis data generated by the machine-learned trip check model to the second portion of the set of ground-truth data. For example, after receiving such predictions, a training computing system can apply or otherwise determine a loss function that compares the trip check analysis data output by the machine-learned trip check model to the remainder of the ground-truth data (e.g., ground-truth labels) which the trip check model attempted to predict.

At 610, the computing system can backpropogate the loss function through the machine-learned trip check model to train the model (e.g., by modifying one or more weights associated with the model). This process of inputting ground-truth data, determining a loss function, and backpropagating the loss function through the trip check model can be repeated numerous times as part of training the trip check model. For example, the process can be repeated for each of numerous sets of ground-truth data provided within the trip check training dataset.

FIG. 7 depicts a block diagram of an example computing system 700 according to example embodiments of the present disclosure. The example computing system 700 includes a computing system 710 and a machine learning computing system 750 that are communicatively coupled over a network 740.

In some implementations, the computing system 710 can perform various operations including the determination of one or more states of a vehicle (e.g., the vehicle 102 of FIG. 1) including the vehicle's location, position, orientation, velocity, and/or acceleration; determination of the state of the environment proximate to the vehicle including the state of one or more objects proximate to the vehicle (e.g., the object's physical dimensions, location, position, orientation, velocity, acceleration, shape, and/or color); the determination of one or more states of one or more objects internal to the vehicle (e.g., one or more passengers of the vehicle, objects left within the vehicle, etc.); the determination of one or more types of trip check data associated with a vehicle trip; and/or the like. In some implementations, the computing system 710 can be included in an autonomous vehicle (e.g., the vehicle 102 of FIG. 1). For example, the computing system 710 can be on-board the autonomous vehicle. In other implementations, the computing system 710 is not located on-board the autonomous vehicle. For example, the computing system 710 can operate offline to determine one or more states of a vehicle (e.g., the vehicle 102 of FIG. 1) including the vehicle's location, position, orientation, velocity, and/or acceleration; determination of the state of the environment proximate to the vehicle including the state of one or more objects proximate to the vehicle (e.g., the object's physical dimensions, location, position, orientation, velocity, acceleration, shape, and/or color); the determination of one or more states of one or more objects internal to the vehicle (e.g., one or more passengers of the vehicle, objects left within the vehicle, etc.); the determination of one or more types of trip check data associated with a vehicle trip; and/or the like. Further, the computing system 710 can include one or more distinct physical computing devices.

The computing system 710 includes one or more processors 712 and a memory 714. The one or more processors 712 can be any suitable processing device (e.g., a processor core, a microprocessor, an ASIC, a FPGA, a controller, and/or a microcontroller) and can be one processor or a plurality of processors that are operatively connected. The memory 714 can include one or more non-transitory computer-readable storage media, including RAM, ROM, EEPROM, EPROM, one or more memory devices, flash memory devices, and/or combinations thereof.

The memory 714 can store information that can be accessed by the one or more processors 712. For instance, the memory 714 (e.g., one or more non-transitory computer-readable storage mediums, memory devices) can store data 716 that can be obtained, received, accessed, written, manipulated, created, and/or stored. The data 716 can include, for instance, data associated with the determination of the state of a vehicle, the state of one or more passengers of the vehicle, the state of one or more objects internal to the vehicle, the state of one or more objects external to the vehicle, and/or the like as described herein. In some implementations, the computing system 710 can obtain data from one or more memory devices that are remote from the system 710.

The memory 714 can also store computer-readable instructions 718 that can be executed by the one or more processors 712. The instructions 718 can be software written in any suitable programming language or can be implemented in hardware. Additionally, or alternatively, the instructions 718 can be executed in logically and/or virtually separate threads on the one or more processors 712.

For example, the memory 714 can store instructions 718 that when executed by the one or more processors 712 cause the one or more processors 712 to perform any of the operations and/or functions described herein, including, for example, determining the state of a vehicle (e.g., the vehicle 102 of FIG. 1), the state of one or more passengers, the state of one or more objects, trip check data, and/or trip check control signals.

According to an aspect of the present disclosure, the computing system 710 can store or include one or more machine-learned models 730. As examples, the machine-learned model(s) 730 can be or can otherwise include various machine-learned models including, for example, neural networks (e.g., deep neural networks), support vector machines, decision trees, ensemble models, k-nearest neighbors models, Bayesian networks, or other types of models including linear models and/or non-linear models. Example neural networks include feed-forward neural networks, recurrent neural networks (e.g., long short-term memory recurrent neural networks), convolutional neural networks, or other forms of neural networks. In some implementations, machine-learned model(s) 730 can include a machine-learned trip check model (e.g., machine-learned trip check model 204 of FIG. 2). In some implementations, the machine-learned model(s) 730 can include one or more different machine-learned trip check models to provide for different stages of trip check analysis operations (e.g. first trip check analysis 412, second trip check analysis 414, and third trip check analysis 416 of FIG. 4, and/or the like).

In some implementations, the computing system 710 can receive the one or more machine-learned models 730 from the machine learning computing system 750 over the network 740 and can store the one or more machine-learned models 730 in the memory 714. The computing system 710 can then use or otherwise implement the one or more machine-learned models 730 (e.g., by the one or more processors 712). In particular, the computing system 710 can implement the one or more machine-learned models 730 to determine trip check data such as object identification parameters, object classification data, object location data, safety system verification data, vehicle interior damage/deviation data, and/or the like.

In some implementations, the computing system 710 can include a trip check controller 732 that can receive various input data (e.g., trip check analysis data such as trip check analysis data 206 of FIG. 2, etc.) and provide one or more trip control signals associated with operation of the vehicle. For example, a trip check controller 732 can obtain one or more of trip check analysis data, trip data, and/or vehicle status data for use in determining one or more trip control signals, such as a vehicle readiness signal, a trip completion signal, a deviation detection signal, a remediation signal, a remote assistance request signal, and/or the like. The trip check controller 732 can provide the one or more trip control signals to an appropriate vehicle controller and/or system to assist in implementing a desired response to the trip analysis data.

The machine learning computing system 750 includes one or more processors 752 and memory 754. The one or more processors 752 can be any suitable processing device (e.g., a processor core, a microprocessor, an ASIC, a FPGA, a controller, and/or a microcontroller) and can be one processor or a plurality of processors that are operatively connected. The memory 754 can include one or more non-transitory computer-readable storage media, including RAM, ROM, EEPROM, EPROM, one or more memory devices, flash memory devices, and/or combinations thereof.

The memory 754 can store information that can be accessed by the one or more processors 752. For instance, the memory 754 (e.g., one or more non-transitory computer-readable storage mediums, memory devices) can store data 756 that can be obtained, received, accessed, written, manipulated, created, and/or stored. The data 756 can include, for instance, data associated with the determination of the state of a vehicle, the state of one or more passengers of the vehicle, the state of one or more objects internal to the vehicle, the state of one or more objects external to the vehicle, and/or the like as described herein. In some implementations, the machine learning computing system 750 can obtain data from one or more memory devices that are remote from the system 750.

The memory 754 can also store computer-readable instructions 758 that can be executed by the one or more processors 752. The instructions 758 can be software written in any suitable programming language or can be implemented in hardware. Additionally, or alternatively, the instructions 758 can be executed in logically and/or virtually separate threads on the one or more processors 752.

For example, the memory 754 can store instructions 758 that when executed by the one or more processors 752 cause the one or more processors 752 to perform any of the operations and/or functions described herein, including, for example, determining the state of a vehicle (e.g., the vehicle 102 of FIG. 1), the state of one or more passengers, the state of one or more objects, trip check data, and/or trip check control signals.

In some implementations, the machine learning computing system 750 includes one or more server computing devices. If the machine learning computing system 750 includes multiple server computing devices, such server computing devices can operate according to various computing architectures, including, for example, sequential computing architectures, parallel computing architectures, or some combination thereof.

In addition or alternatively to the one or more machine-learned models 730 at the computing system 710, the machine learning computing system 750 can include one or more machine-learned models 770. As examples, the one or more machine-learned models 770 can be or can otherwise include various machine-learned models including, for example, neural networks (e.g., deep convolutional neural networks), support vector machines, decision trees, ensemble models, k-nearest neighbors models, Bayesian networks, or other types of models including linear models and/or non-linear models. Example neural networks include feed-forward neural networks, recurrent neural networks (e.g., long short-term memory recurrent neural networks), convolutional neural networks, or other forms of neural networks. In some implementations, machine-learned models 770 can include a machine-learned trip check model (e.g., machine-learned ride experience model 204 of FIG. 2). In some implementations, the machine-learned model(s) 770 can include one or more different machine-learned trip check models to provide for different stages of trip check analysis operations (e.g. first trip check analysis 412, second trip check analysis 414, and third trip check analysis 416 of FIG. 4, and/or the like).

As an example, the machine learning computing system 750 can communicate with the computing system 710 according to a client-server relationship. For example, the machine learning computing system 750 can implement the one or more machine-learned models 770 to provide a service to the computing system 710. For example, the service can provide for determining trip check data and/or trip check control signals as described herein.

Thus the one or more machine-learned models 730 can located and used at the computing system 710 and/or the one or more machine-learned models 770 can be located and used at the machine learning computing system 750.

In some implementations, the machine learning computing system 750 and/or the computing system 710 can train the machine-learned model(s) 730 and/or 770 through use of a model trainer 780. The model trainer 780 can train the machine-learned model(s) 730 and/or 770 using one or more training or learning algorithms. One example training technique is backwards propagation of errors. In some implementations, the model trainer 780 can perform supervised training techniques using a set of labeled training data. In other implementations, the model trainer 780 can perform unsupervised training techniques using a set of unlabeled training data. The model trainer 780 can perform a number of generalization techniques to improve the generalization capability of the models being trained. Generalization techniques include weight decays, dropouts, or other techniques.

In particular, the model trainer 780 can train the one or more machine-learned models 730 and/or the one or more machine-learned models 770 based on a set of training data 782. The training data 782 can include, for example, a plurality of sensor data, a variety of sample data associated with the interior of a vehicle, a variety of passenger data samples, a variety of sound samples, representations of sensor data and corresponding labels that describe corresponding trip check data, and/or the like. The model trainer 780 can be implemented in hardware, firmware, and/or software controlling one or more processors.

In some implementations, the machine-learned model(s) 730 and/or 770 can include one or more different machine-learned trip check models (e.g., first machine-learned trip check model(s), second machine-learned trip check model(s), and/or third machine-learned trip check model(s)) to provide for different stages of trip check analysis operations (e.g. first trip check analysis 412, second trip check analysis 414, and third trip check analysis 416 of FIG. 4, and/or the like). In such implementations, the first machine-learned trip check model(s), second machine-learned trip check model(s), and/or third machine-learned trip check model(s) may be trained using distinct sets of training data 782 such that the first machine-learned trip check model(s), second machine-learned trip check model(s), and/or third machine-learned trip check model(s) provide for generation of different types of trip check analysis data.

The computing system 710 can also include a network interface 720 used to communicate with one or more systems or devices, including systems or devices that are remotely located from the computing system 710. The network interface 720 can include any circuits, components, and/or software, for communicating with one or more networks (e.g., the network 740). In some implementations, the network interface 720 can include, for example, one or more of a communications controller, receiver, transceiver, transmitter, port, conductors, software, and/or hardware for communicating data. Similarly, the machine learning computing system 750 can include a network interface 760.

The networks 740 can be any type of network or combination of networks that allows for communication between devices. In some embodiments, the network 740 can include one or more of a local area network, wide area network, the Internet, secure network, cellular network, mesh network, peer-to-peer communication link, and/or some combination thereof, and can include any number of wired or wireless links. Communication over the network 740 can be accomplished, for instance, via a network interface using any type of protocol, protection scheme, encoding, format, and/or packaging.

FIG. 7 illustrates one example computing system 700 that can be used to implement the present disclosure. Other computing systems can be used as well. For example, in some implementations, the computing system 710 can include the model trainer 780 and the training dataset 782. In such implementations, the machine-learned models 730 can be both trained and used locally at the computing system 710. As another example, in some implementations, the computing system 710 is not connected to other computing systems.

In addition, components illustrated and/or discussed as being included in one of the computing systems 710 or 750 can instead be included in another of the computing systems 710 or 750. Such configurations can be implemented without deviating from the scope of the present disclosure. The use of computer-based systems allows for a great variety of possible configurations, combinations, and divisions of tasks and functionality between and among components. Computer-implemented operations can be performed on a single component or across multiple components. Computer-implemented tasks and/or operations can be performed sequentially or in parallel. Data and instructions can be stored in a single memory device or across multiple memory devices.

Computing tasks discussed herein as being performed at computing device(s) remote from the autonomous vehicle can instead be performed at the autonomous vehicle (e.g., via the vehicle computing system), or vice versa. Such configurations can be implemented without deviating from the scope of the present disclosure. The use of computer-based systems allows for a great variety of possible configurations, combinations, and divisions of tasks and functionality between and among components. Computer-implemented operations can be performed on a single component or across multiple components. Computer-implements tasks and/or operations can be performed sequentially or in parallel. Data and instructions can be stored in a single memory device or across multiple memory devices.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

What is claimed is:

1. A computer-implemented method, comprising:
obtaining, by a computing system comprising one or more computing devices, sensor data from one or more sensors positioned within a cabin of a vehicle, the sensor data being descriptive of objects located within the cabin of the vehicle;
inputting, by the computing system, the sensor data to a machine-learned trip check model;
receiving, by the computing system as an output of the machine-learned trip check model, trip check analysis data;
determining, by the computing system and based on the trip check analysis data, that the trip check analysis data meets one or more predetermined criteria; and
in response to determining that the trip check analysis data meets the one or more predetermined criteria, generating a trip control signal associated with operation of the vehicle.

2. The computer-implemented method claim 1, wherein:
the sensor data is obtained prior to a commencement of a service trip;
the trip check analysis data comprises one or more object identification parameters indicative of whether one or more objects of interest are detected within the cabin of the vehicle based on the sensor data;
determining that the trip check analysis data meets one or more predetermined criteria comprises determining that the one or more object identification parameters indicates that no objects of interest are detected within the cabin of the vehicle; and
in response to determining that the one or more object identification parameters indicates that no objects of interest are detected within the cabin of the vehicle, generating the trip control signal comprises generating an authorization to dispatch the vehicle to a location for starting the service trip.

3. The computer-implemented method of claim 1, wherein:
the trip check analysis data comprises one or more object identification parameters indicative of whether one or more objects of interest are detected within the cabin of the vehicle based on the sensor data;
determining that the trip check analysis data meets one or more predetermined criteria comprises determining that the one or more object identification parameters indicates that one or more objects of interest are detected within the cabin of the vehicle; and
in response to determining that the one or more object identification parameters indicates that one or more objects of interest are detected within the cabin of the vehicle, the method further comprises generating a classification for each object of interest and a location for each object of interest.

4. The computer-implemented method of claim 3, wherein the classification for each object of interest comprises one of:
a rider;
a user personal object; or
a non-defined object.

5. The computer-implemented method of claim 4, wherein:
the sensor data is obtained prior to a commencement of a service trip;
the one or more object identification parameters comprises a count of a number of objects of interest having the classification comprising the rider;
determining that the trip check analysis data meets one or more predetermined criteria comprises determining if the count of the number of objects of interest having the classification comprising the rider is greater than a predefined number of riders associated with the service trip or less than or equal to the predefined number;
in response to determining that the count of the number of objects of interest having the classification comprising the rider is greater than the predefined number, generating the trip control signal comprises generating a notification that the service trip cannot begin and generating a remediation request; and
in response to determining that the count of the number of objects of interest having the classification comprising the rider is less than or equal to the predefined number, generating the trip control signal comprises generating an authorization that the service trip can be commenced.

6. The computer-implemented method of claim 4, wherein:
the sensor data is obtained prior to a commencement of a service trip;
the trip check analysis data further comprises a safety system verification parameter for each object of interest having a classification comprising the rider;
determining that the trip check analysis data meets one or more predetermined criteria comprises determining if the safety system verification parameter passes or fails for each object of interest having the classification comprising the rider;
in response to determining that the safety system verification parameter fails for any object of interest having the classification comprising the rider, generating the trip control signal comprises generating a notification that the service trip cannot begin and generating a remediation request; and
in response to determining that the safety system verification parameter passes for each object of interest having the classification comprising the rider, generating the trip control signal comprises generating an authorization that the service trip can be commenced.

7. The computer-implemented method of claim 4, wherein:
the sensor data is obtained incident to a conclusion of a service trip;
determining that the trip check analysis data meets one or more predetermined criteria comprises determining that at least one of the one or more objects of interest has a classification comprising the user personal object and that none of the one or more objects of interest has a classification comprising the rider; and
in response to determining that at least one of the one or more objects of interest has a classification comprising the user personal object and that none of the one or more objects of interest has the classification comprising the rider, generating the trip control signal comprises generating a request for assistance from a remote operator including a notification that a rider object may have been left behind.

8. The computer-implemented method of claim 1, wherein:
the sensor data is obtained incident to a conclusion of a service trip;
the trip check analysis data comprises one or more object identification parameters indicative of whether one or more objects of interest are detected within the cabin of the vehicle based on the sensor data;
determining that the trip check analysis data meets one or more predetermined criteria comprises determining that the one or more object identification parameters indicates that no objects of interest are detected within the cabin of the vehicle; and
in response to determining that the one or more object identification parameters indicates that no objects of interest are detected within the cabin of the vehicle, generating the trip control signal comprises generating an authorization to dispatch the vehicle to a new location for starting a new service trip.

9. The computer-implemented method of claim 1, wherein the sensor data comprises image data from one or more image sensors positioned within the cabin of the vehicle.

10. A computing system, comprising:
one or more image sensors positioned within a cabin of a vehicle and configured to obtain image data being descriptive of objects located within the cabin of the vehicle;
one or more processors;
a machine-learned trip check model that has been trained to analyze the image data to generate trip analysis data in response to receipt of the image data; and
at least one tangible, non-transitory computer readable medium that stores instructions that, when executed by the one or more processors, cause the one or more processors to perform operations, the operations comprising:
providing real-time samples of the image data to the machine-learned trip check model;
receiving, as an output of the machine-learned trip check model, trip analysis data; and
generating, based at least in part on the trip check analysis data, a trip control signal associated with operation of the vehicle.

11. The computing system of claim 10, wherein:
the trip check analysis data comprises one or more object identification parameters indicative of whether one or more objects of interest are detected within the cabin of the vehicle based on the image data;
the operations further comprising:
determining that the one or more object identification parameters indicates that one or more objects of interest are detected within the cabin of the vehicle; and
in response to determining that the one or more object identification parameters indicates that one or more objects of interest are detected within the cabin of the vehicle, generating a classification for each object of interest and a location for each object of interest.

12. The computing system of claim 11, wherein the classification for each objects of interest comprises one of:
a rider;
a user personal object; or
a non-defined object.

13. The computing system of claim 12, wherein:
the image data is obtained prior to a commencement of a service trip; and
the one or more object identification parameters comprises a count of a number of objects of interest having the classification comprising the rider;
the operations further comprising determining if the count of the number of objects of interest having the classification comprising the rider is greater than a predefined number of riders associated with the service trip or less than or equal to the predefined number;
wherein in response to determining that the count of the number of objects of interest having the classification comprising the rider is greater than the predefined number, generating the trip control signal comprises generating a notification that the service trip cannot begin and generating a remediation request; and
wherein in response to determining that the count of the number of objects of interest having the classification comprising the rider is less than or equal to the predefined number, generating the trip control signal comprises generating an authorization that the service trip can be commenced.

14. The computing system of claim 12, wherein:
the image data is obtained prior to a commencement of a service trip; and
the trip check analysis data further comprises a safety system verification parameter for each object of interest having the classification comprising the rider;
the operations further comprising determining if the safety system verification parameter passes or fails for each object of interest having the classification comprising the rider;
wherein in response to determining that the safety system verification parameter fails for any object of interest having the classification comprising the rider, generating the trip control signal comprises generating a notification that the service trip cannot begin and generating a remediation request; and
wherein in response to determining that the safety system verification parameter passes for each object of interest having the classification comprising the rider, generating the trip control signal comprises generating an authorization that the service trip can be commenced.

15. The computing system of claim 12, wherein:
the image data is obtained incident to a conclusion of a service trip;
the operations further comprising determining that at least one of the one or more objects of interest has the classification comprising the user personal object and that none of the one or more objects of interest has the classification comprising the rider; and
in response to determining that at least one of the one or more objects of interest has a classification comprising the user personal object and that none of the one or more objects of interest has the classification comprising the rider, generating the trip control signal comprises generating a request for assistance from a remote operator including a notification that a rider object may have been left behind.

16. An autonomous vehicle, comprising:
a sensor system comprising one or more sensors for obtaining image data associated with one or more objects within the autonomous vehicle;
a vehicle computing system comprising:
one or more processors; and
at least one tangible, non-transitory computer readable medium that stores instructions that, when executed by the one or more processors, cause the one or more processors to perform operations, the operations comprising:
inputting the image data to a machine-learned trip check model;
receiving, as an output of the machine-learned trip check model, trip check analysis data;
determining, based at least in part on the trip check analysis data, that the trip check analysis data meets one or more predetermined criteria; and
in response to determining that the trip check analysis data meets one or more predetermined criteria, generating a trip control signal associated with operation of the vehicle.

17. The autonomous vehicle of claim 16, wherein the trip check analysis data comprises one or more object identification parameters indicative of whether one or more objects of interest are detected within a cabin of the vehicle based on the image data;
determining that the trip check analysis data meets one or more predetermined criteria comprises determining that the one or more object identification parameters indicates that one or more objects of interest are detected within the cabin of the vehicle; and
in response to determining that the one or more object identification parameters indicates that one or more objects of interest are detected within the cabin of the vehicle, the operations further comprise generating a classification for each object of interest and a location for each object of interest.

18. The autonomous vehicle of claim 17, wherein the classification for each object of interest comprises one of:
a rider;
a user personal object; or
a non-defined object.

19. The autonomous vehicle of claim 18, wherein: the image data is obtained prior to a commencement of a service trip;
the one or more object identification parameters comprises a count of a number of objects of interest having the classification comprising the rider;
determining that the trip check analysis data meets one or more predetermined criteria comprises determining if the count of the number of objects of interest having the classification comprising the rider is greater than a predefined number of riders associated with the service trip or less than or equal to the predefined number;
in response to determining that the count of the number of objects of interest having the classification comprising the rider is greater than the predefined number, generating the trip control signal comprises generating a notification that the service trip cannot begin and generating a remediation request; and
in response to determining that the count of the number of objects of interest having the classification comprising the rider is less than or equal to the predefined number, generating the trip control signal comprises generating an authorization that the service trip can be commenced.

20. The autonomous vehicle of claim 18, wherein:
the sensor data is obtained incident to a conclusion of a service trip;
determining that the trip check analysis data meets one or more predetermined criteria comprises determining that at least one of the one or more objects of interest has the classification comprising the user personal object and that none of the one or more objects of interest has a classification comprising the rider; and
in response to determining that at least one of the one or more objects of interest has a classification comprising the user personal object and that none of the one or more objects of interest has the classification comprising the rider, generating the trip control signal comprises generating a request for assistance from a remote operator including a notification that a rider object may have been left behind.
